(19) United States
(12) Patent Application Publication
(10) Pub. No.: US 2025/0072668 A1
(43) Pub. Date: Mar. 6, 2025

(54) FOOD CONTAINER

(71) Applicant: Lindsey Schafer, Cumming, GA (US)

(72) Inventor: Lindsey Schafer, Cumming, GA (US)

(21) Appl. No.: 18/823,134

(22) Filed: Sep. 3, 2024

Related U.S. Application Data
(60) Provisional application No. 63/536,254, filed on Sep. 1, 2023.

(51) Int. Cl. A47J 47/12

(52) U.S. Cl. CPC A47J 47/12

(57) ABSTRACT

A food container includes a container base defining an upper base surface, the upper base surface defining a food support region configured to support a food item thereon; a container lid removably engaging the container base in a closed configuration, wherein the container base and the container lid together define a container cavity in the closed configuration for enclosing the food item, the container lid being substantially transparent for visibility of the food item enclosed within the container cavity.

### CROSS-REFERENCE TO RELATED APPLICATIONS

The present application claims the benefit of U.S. Provisional Application No. 63/536,254, filed Sep. 1, 2023, which is hereby specifically incorporated by reference herein in its entirety.

### TECHNICAL FIELD

This disclosure relates to containers for food items. More specifically, this disclosure relates to a food container having a transparent lid.

### BACKGROUND

Loaves of bread are often stored in bread boxes that are non-decorative and opaque, making it difficult to attractively display and see the bread. Loaves of bread can also be wrapped in foil or plastic wrap, which can also make it difficult to see the bread, and it can be tedious to remove and replace the wrapping.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a food container comprising a container base defining an upper base surface, the upper base surface defining a food support region configured to support a food item thereon; a container lid removably engaging the container base in a closed configuration, wherein the container base and the container lid together define a container cavity in the closed configuration for enclosing the food item, the container lid being substantially transparent for visibility of the food item enclosed within the container cavity.

Also disclosed is a method of storing a food item in a food container, the method comprising providing the food container, the food container comprising a container base and a container lid, the container base defining an upper base surface, the upper base surface defining a food support region configured to support the food item thereon, the container lid being substantially transparent; positioning the food item on the food support region in an open configuration of the food container; placing the container lid onto the container base in a closed configuration of the food container, the container base and the container lid together define a container cavity in the closed configuration for enclosing the food item.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a perspective view of a bread container, in accordance with one aspect of the present disclosure.

FIG. 2 is a perspective view of the bread container in accordance with another aspect of the present disclosure,

FIG. 3 is a perspective view of the bread container of FIG. 2, with a bread loaf received in the bread container.

FIG. 4 is a top perspective view of a container lid of the bread container of FIG. 2.

FIG. 5 is a top perspective view of a container base of the bread container of FIG. 2.

FIG. 6 is an end view of the bread container of FIG. 2.

FIG. 7 is a perspective view of the container lid being removed from the container base of the bread container of FIG. 2.

FIG. 8 is a perspective view of the bread container, in accordance with another aspect of the present disclosure.

FIG. 9 is a perspective view of the container base of the bread container of FIG. 8.

FIG. 10 is an end view of the bread container of FIG. 8.

FIG. 11 is a front view of the bread container of FIG. 8.

FIG. 12 is a perspective view of the bread container of FIG. 8, with a bread loaf received therein.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a bread container and associated methods, systems, devices, and various apparatus. Example aspects of the bread container can comprise a container base and a container lid configured to removably engage the container base in a closed configuration. It would be understood by one of skill in the art that the bread container is described in but a few exemplary embodiments among many. No particular terminology or description should be considered limiting on the disclosure or the scope of any claims issuing therefrom.

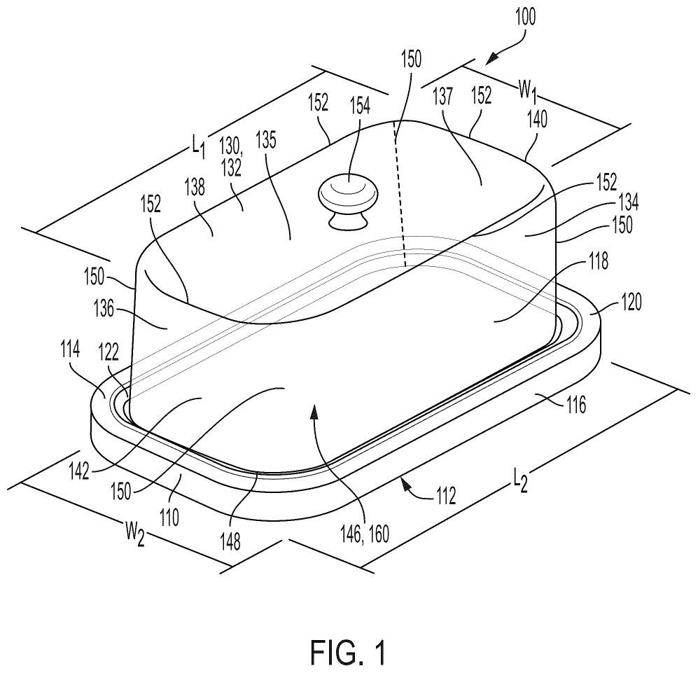

FIG. 1 is a perspective view of a food container, which can be a bread container 100 for example, in accordance with one aspect of the present disclosure. According to example aspects, the bread container 100 can comprise a container base 110 and a container lid 130. The bread container 100 can be configured in a closed configuration (shown) and an open configuration (shown in FIG. 7). In the closed configuration, the container lid 130 can removably engage the container base 110 to define an enclosed container cavity 160 for receiving a loaf of bread 300 (shown in FIG. 3). The loaf of bread 300 can be enclosed in the container cavity 160 by the container base 110 and the container lid 130 in the closed configuration. In the present view, the container cavity 160 can be seen through the container lid 130, which can be substantially transparent in the present aspect. In the closed configuration, the loaf of bread 300 can be easily transported and/or stored. The fully enclosed container cavity 160 can also aid in maintaining the freshness of the loaf of bread 300 and can keep the loaf of bread 300 from becoming stale. In the open configuration, the container lid 130 can be removed from the container base 110 to allow access to the loaf of bread 300. The loaf of bread 300 received in the container cavity 160 can be whole, sliced, or partially sliced. It will also be appreciated by those skilled in the art that the bread container 100 can contain various other baked goods and/or food items in addition to or alternative to loaves of bread 300.

Example aspects of the container base 110 can be substantially rectangular in shape, as shown. In other aspects, the container base 110 can define any other suitable shape, including but not limited to, square, circular, or the like. The container base 110 can define a lower base surface 112 and an upper base surface 114 opposite the lower base surface 112. A base sidewall 116 can extend between the lower base surface 112 and the upper base surface 114. The lower base surface 112 can be configured to rest on a support surface, such as a countertop or table for example. The upper base surface 114 can define a food support region, such as bread support region 118 (seen through the transparent container lid 130), configured to support the loaf of bread 300, or other baked good or food item, thereon. The bread support region 118 can be substantially flat in the present aspect. In some aspects, the upper base surface 114 can further define an outer rim portion 120 substantially surrounding the bread support region 118. Example aspects of the upper base surface 114 can further define a lid groove 122 disposed between the outer rim portion 120 and the bread support region 118. As shown, the lid groove 122 can be substantially continuous, such that the lid groove 122 can substantially encircle the bread support region 118.

According to example aspects, the container lid 130 can comprise a lid housing 132. The lid housing 132 can define the shape of a substantially rectangular prism. In other aspects, the lid housing 132 can define any other suitable shape, including but not limited to, a square prism, a cylinder, a dome, or the like. The lid housing 132 can define a first lid sidewall 134, a second lid sidewall 135 opposite the first lid sidewall 134, a first lid end wall 136, and a second lid end wall 137 opposite the first lid end wall 136. The first lid end wall 136 and the second lid end wall 137 can generally define a width W₁ of the container lid 130, and the first lid sidewall 134 and the second lid sidewall 135 can generally define a length L₁ of the container lid 130. In the present aspect, the length L₁ of the container lid 130 can be greater than the width W₁ of the container lid 130. In other aspects, the dimensions of the lid housing 132 can vary.

Additionally, the lid housing 132 can define an upper lid wall 138 at an upper lid end 140 of the lid housing 132. The upper lid wall 138 can be substantially planar in the present aspect; however, in other aspects, the upper lid wall 138 may be domed or otherwise non-planar. The lid housing 132 can further define an outer lid surface 142 and an inner lid surface 744 (seen through the transparent container lid 130 in the present aspect, but labeled and best shown in FIG. 7). The inner lid surface 744 can define a lid cavity 146 (seen through the transparent container lid 130) of the container lid 130. The lid housing 132 can be open at a lower lid end 148 opposite the upper lid end 140 to allow access to the lid cavity 146, as best seen in FIG. 7.

According to example aspects, the lower lid end 148 of the lid housing 132 can engage the lid groove 122 of the container base 110 in the closed configuration to prevent the container lid 130 from sliding on the upper base surface 114. More specifically, the first lid sidewall 134, the second lid sidewall 135, the first lid end wall 136, and the second lid end wall 137 can engage the lid groove 122 at the lower lid end 148. The outer rim portion 120 of the container base 110 can extend outward past each of the first lid sidewall 134, the second lid sidewall 135, the first lid end wall 136, and the second lid end wall 137 of the container lid 130. Thus, as shown, a width W₂ of the container base 110 can be greater than the width W₁ of the container lid 130, and a length L₂ of the container base 110 can be greater than the length L₁ of the container lid 130. In the sealed configured, the bread support region 118 of the container base 110 can enclose the lid cavity 146 of the container lid 130 at the open lower lid end 148 to define the enclosed container cavity 160 and to seal the loaf of bread 300 therein.

In some aspects, as shown, substantially vertical wall edges 150 defined between adjacent pairs of the first lid sidewall 134, the second lid sidewall 135, the first lid end wall 136, and the second lid end wall 137 can be substantially rounded or chamfered. Similarly, substantially horizontal transition edges 152 defined between the upper lid wall 138 and each of the first lid sidewall 134, the second lid sidewall 135, the first lid end wall 136, and the second lid end wall 137 can be substantially rounded or chamfered. In other aspects, any of the substantially vertical wall edges 150 and/or the substantially horizontal transition edges 152 can be less rounded and more angular.

Example aspects of the container lid 130 can further comprise one or handgrips, such as one or more knobs 154 and/or handles, that a user can grip to remove the container lid 130 from the container base 110 and to replace the container lid 130 back onto the container base 110. In the present aspect of the container lid 130, a singular knob 154 can extend outward from a center of the upper lid wall 138. The knob 154 can be formed monolithically (i.e., formed as a singular component that constitutes a single material without joints or seams) with the lid housing 132, as shown, or can be formed separately from the lid housing 132 and attached thereto. In other aspects, the one or more knobs 154 or handles, or other suitable handgrip, can extend from the lid housing 132 at any other suitable location. For example, in another particular example aspect, the container lid 130 can comprise a pair of opposing handles, wherein each of the opposing handles can extend from one of the first lid end wall 136 and the second lid end wall 137. Other aspects of the container lid 130 may not comprise any knobs 154, handles, or other handgrips.

In some aspects, the container base 110 can comprise a wood material, such as bamboo or maple for example, a metal material, such as stainless steel for example, a plastic material, glass, ceramic, china, porcelain, earthenware, stoneware, or any other suitable material or combination of materials known in the art. Such wood materials can include either or both of harder wood materials and softer wood materials. In some aspects, the container base 110 can comprise a substantially opaque material; however, in other aspects, the material of the container base 110 can be translucent or transparent. Furthermore, in some aspects, the container lid 130 can comprise a plastic material, such as acrylic, Tritan, polypropylene, polycarbonate, or styrene acrylonitrile (SAN) for example, glass, melamine or melamine resin, another resin or clear resin, such as K-Resin® for example, or any other suitable material or combination of materials known in the art. In some aspects, the container lid 130 can comprises a substantially transparent material such that the container cavity 160 is visible through the container lid 130; however, in other aspects, the material of the container lid 130 can be translucent or opaque.

In the present aspect, the bread container 100 can be sized to enclose a standard size loaf of bread 300, which can be about 8.5 inches in length and about 4.5 inches in width. Thus, in example aspects, a length of the bread support region 118 can be about 9 inches and a width of the bread support region 118 can be about 5 inches. In other aspects, the dimensions and/or shape of the bread container 100 can vary to suitably enclose smaller or larger loaves of bread 300 or other food items of varying shapes and sizes. For example, in a particular example aspect, the dimensions of the bread container 100 can be reduced, such that the bread container 100 can be sized to enclose a standard “mini” loaf of bread 300, which can be about 5 inches in length and about 3 inches in width.

Moreover, a thickness of the container base 110 (i.e., a height of the base sidewall 116 between the lower base surface 112 and the upper base surface 114) can be selected as desired. For example, in a particular aspect, the thickness of the container base 110 can be about 1 inch. In other aspects, the thickness of the container base 110 can be greater or lesser than one inch. Furthermore, in some example aspects, the lower base surface 112 can rest directly on a support surface, as previously described. In other aspects, the container base 110 can be supported above the support surface by a pedestal or support leg(s).

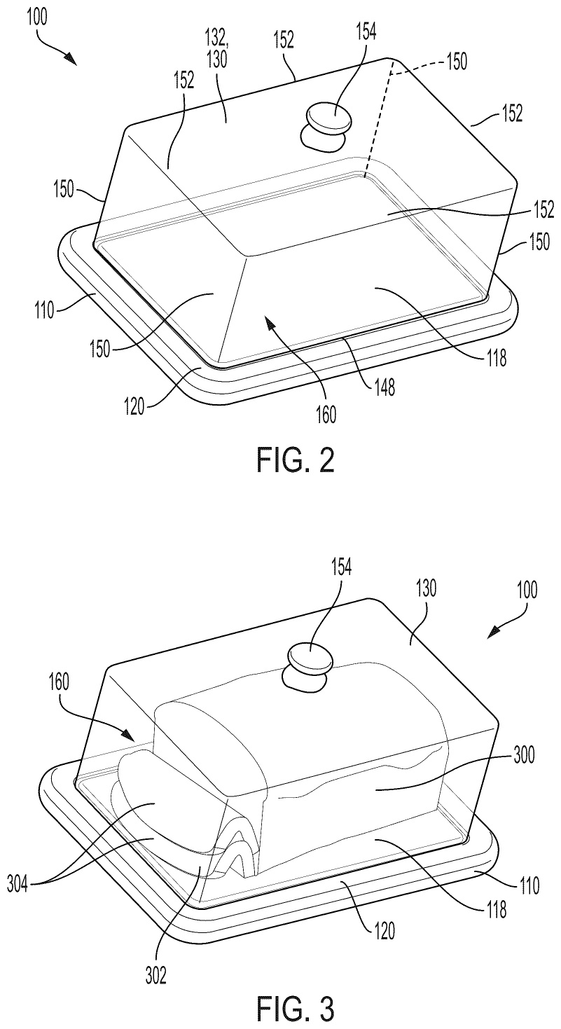

FIGS. 2-7 illustrate the bread container 100 in accordance with another example aspect of the present disclosure. Referring to FIG. 2, the bread container 100 is shown in the closed configuration. The bread container 100 of the present aspect can be similar to the bread container 100 of FIG. 1, with a few differences. For example, in the present aspect, the substantially vertical wall edges 150 and the substantially horizontal transition edges 152 of the container lid 130 can be less rounded/chamfered and more angular. Additionally, in the present aspect, the bread container 100 may not define the lid groove 122 (shown in FIG. 1) between the outer rim portion 120 and the bread support region 118 (seen through the transparent container lid 130). Instead, the outer rim portion 120 can be recessed or indented from the bread support region 118, and the lower lid end 148 of the lid housing 132 can engage the recessed outer rim portion 120 of the container base 110 in the closed configuration. Thus, in the present design, the bread support region 118 can be slightly elevated within the container cavity 160 (seen through the transparent container lid 130) above the outer rim portion 120 of the container base 110 and the lower lid end 148 of the container lid 130. In other aspects, however, the present bread container 100 can define the lid groove 122, as previously described. Moreover, in other aspects, the bread support region 118 can be recessed or indented from the outer rim portion 120, and the lower lid end 148 can engage the recessed bread support region 118 in the closed configuration.

FIG. 3 illustrates the loaf of bread 300 received within the container cavity 160 of the bread container 100 in the closed configuration. As shown, the loaf of bread 300 is supported on the bread support region 118 of the container base 110, and the container base 110 and the container lid 130 can fully surround the loaf of bread 300. A first loaf end 302 of the loaf of bread 300 has been sliced. To access the loaf of bread 300 (e.g., to retrieve a slice 304 of the loaf of bread 300) within the container cavity 160, one can simply grip the knob 154 of the container lid 130 and lift the container lid 130 away from the container base 110.

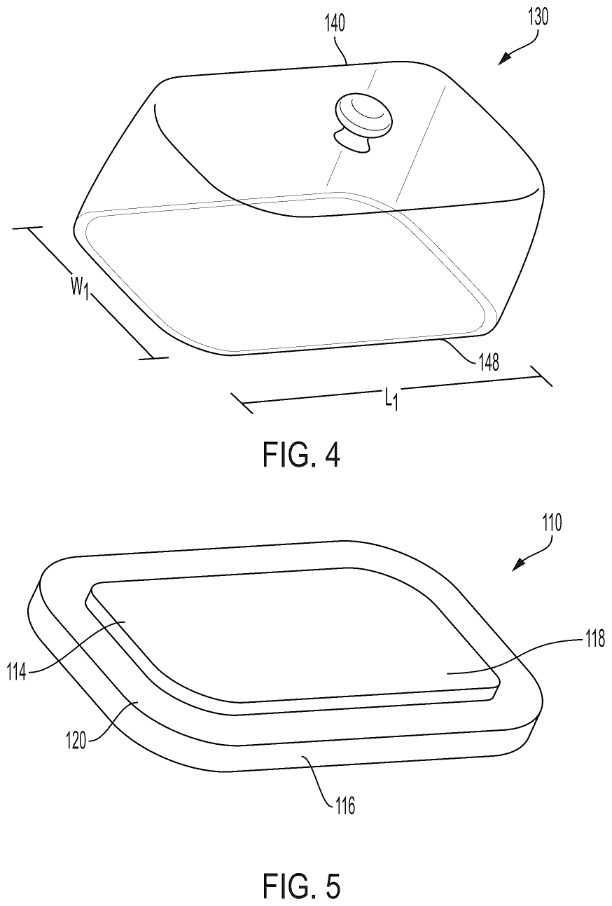

FIG. 4 illustrates a top perspective view of the container lid 130, and FIG. 5 illustrates a top perspective view of the container base 110, both according to example aspects of the present disclosure. Referring to FIG. 4, in some aspects, the width W₁ of the container lid 130 and/or the length L₁ of the container lid 130 can taper inward (i.e., get narrower) generally from the lower lid end 148 to the upper lid end 140. In other aspects, the width W of the container lid 130 and/or the length L₁ of the container lid 130 can be substantially consistent from the lower lid end 148 to the upper lid end 140. In other aspects, the width W₁ and/or the length L₁ of the container lid 130 can taper outward (i.e., get wider) generally from the lower lid end 148 to the upper lid end 140. Referring now to FIG. 5, the outer rim portion 120 of the container lid 130 can surround the bread support region 118. Furthermore, in the present aspect, the outer rim portion 120 can be recessed or indented from the bread support region 118.

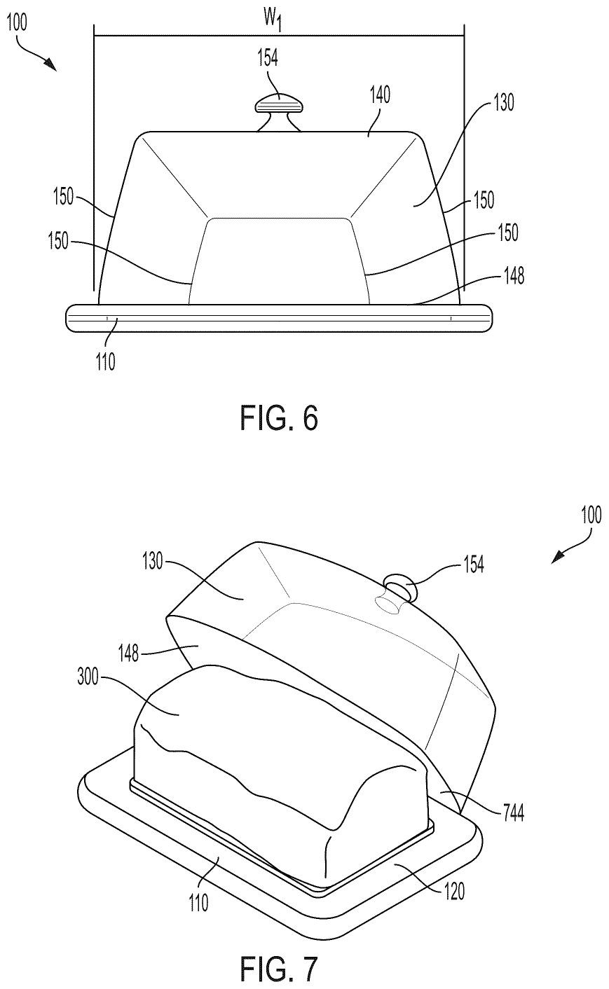

Referring now to the end view of FIG. 6, the inwardly tapering width W₁ of the container lid 130 from the lower lid end 148 to the upper lid end 140 is clearly illustrated. Thus, in example aspects, the substantially vertical wall edges 150 of the container lid 130 can be angled inwards generally from the lower lid end 148 to the upper lid end 140. Moreover, in some aspects, the substantially vertical wall edges 150 of the container lid 130 can be substantially curved or arcuate generally from the lower lid end 148 to the upper lid end 140, as shown. In other aspects, however, the substantially vertical wall edges 150 by not be angled inwards; for example, the substantially vertical wall edges 150 can be totally vertical or can be angled outwards. Furthermore, in other aspects, the substantially vertical wall edges 150 may not be curved or arcuate, and instead can be substantially linear.

FIG. 7 illustrates the bread container 100 in the open configuration, wherein the container lid 130 can be removed from the container base 110 to allow access to the loaf of bread 300 supported on the bread support region 118 (shown in FIG. 1) of the container base 110. A method of using the bread container 100 can comprise gripping the knob 154 or handle and lifting the container lid 130 away from the container base 110 to expose and allow access to the loaf of bread 300. In example aspects, the method can further comprise gripping the knob 154 or handle and lowering the container lid 130 back onto the container base 110. In some aspects, lowering the container lid 130 back onto the container base 110 can comprise engaging the lower lid end 148 with the lid groove 122 (shown in FIG. 1). In other aspects, lowering the container lid 130 back onto the container base 110 can comprise engaging the lower lid end 148 with the recessed outer rim portion 120.

Any feature described herein such as, for example and without limitation, the transparency of the container lid 130, the overall shape of the container base 110, the container lid 130, and/or the bread container 100 as a whole, and other components of the bread container 100 and their arrangement, can comprise both functional and aesthetic elements, and any feature described as having functional aspects can have or define any one of several aesthetic designs without altering the respective parts' functions. If aesthetic elements are shown in the drawings or possibly fall within the scope of broader claim elements without being directly claimed, such disclosure or claims should not be interpreted as assigning any function to such aesthetic elements which may therefore be separately protectable.

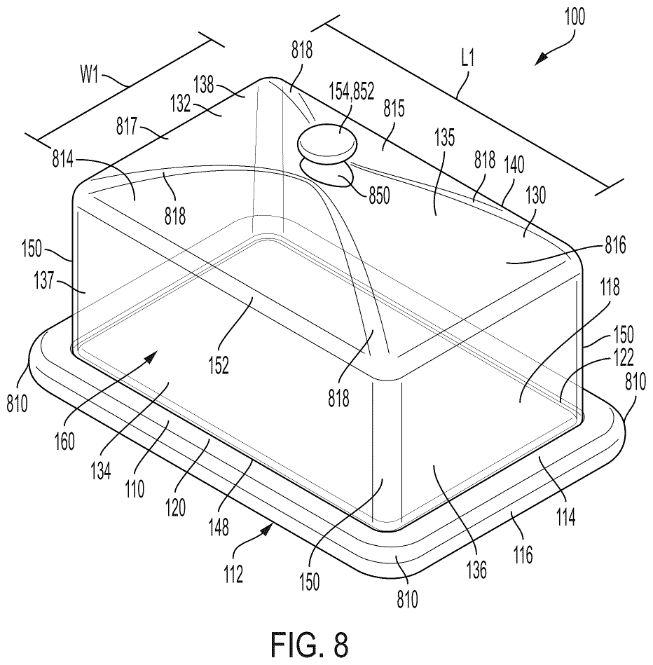

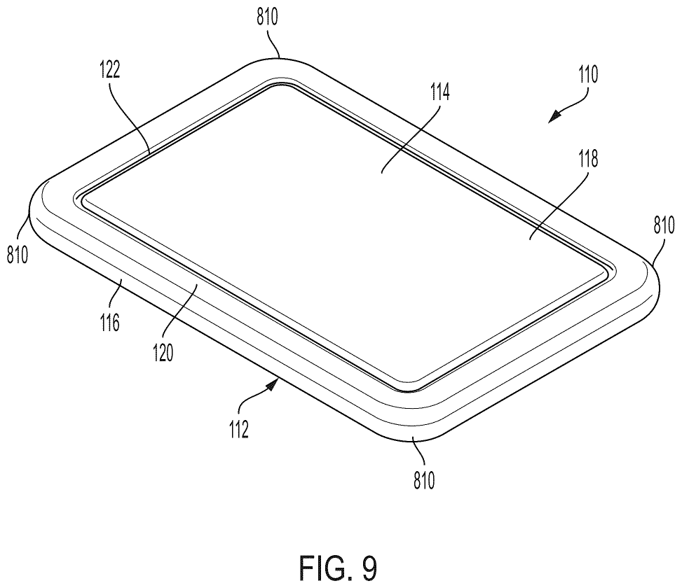

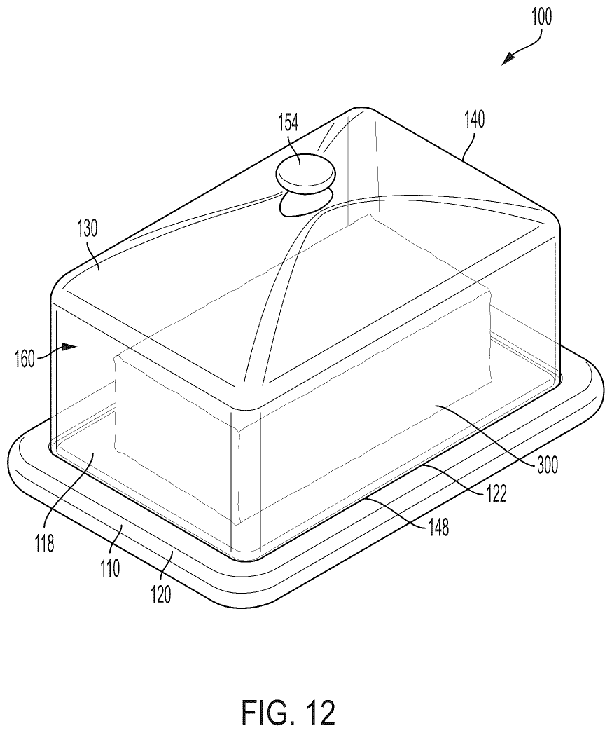

FIGS. 8-12 illustrate the food container (e.g., the bread container 100) in accordance with another aspect of the present disclosure. The bread container 100 of the present aspect can be similar to the bread container 100 previously described. Referring to FIG. 8, the bread container 100 can comprise the container base 110 and the container lid 130. The container lid 130 can be removably mounted on the container base 110 in the closed configuration to define the enclosed container cavity 160 (visible through the substantially transparent container lid 130). As previously described, the loaf of bread 300 (shown in FIG. 12) or other food item can housed within the container cavity 160 in the closed configuration to maintain the freshness of the bread 300. The container lid 130 can be removed from the container base 130 in the open configuration to allow access to the container cavity 160, such as for cutting and retrieving a slice of the bread 300 housed therein. In example aspects, the container lid 130 can be substantially transparent for visibility into the container cavity 160.

The container base 110 can be substantially rectangular in shape. In other aspects, the container base 110 can define any other suitable shape, including but not limited to, square, circular, oval, or the like. The container base 110 can define four base corners 810 that can be substantially rounded, as shown. In other aspects, the base corners 810 can be more angular. The container base 110 can define the lower base surface 112, the upper base surface 114, and the base sidewall 116 extending therebetween. The upper base surface 114 can define the bread support region 118 (seen through the substantially transparent container lid 130), which can be substantially flat and centrally located on the container base 110. The outer rim portion 120 can surround the bread support region 118 and can be arranged external to the container cavity 160. Some aspects of the container base 110 can define a lid groove 122, as shown. Alternatively, the bread support region 118 may simply be recessed relative to the surrounding outer rim portion 120.

The container lid 130 can comprise the lid housing 132 and one or more of the handgrips (e.g., the knob 154). The lid housing 132 can define the first lid sidewall 134, the second lid sidewall 135, the first lid end wall 136, and the second lid end wall 137. The first and second lid sidewalls 134,135 and the first and second lid end walls 136, 137 can together define the shape of a substantially rectangular prism. That is, the first and second lid sidewalls 134,135 can be about parallel to one another and about perpendicular to each of the first and second lid end walls 136,137.

Each of the first and second lid sidewalls 134,135 and the first and second lid end walls 136, 137 can extend between the upper lid end 140 and the lower lid end 148. The lower lid end 148 of the lid housing 132 can engage the lid groove 122 of the container base 110 in the closed configuration to prevent the container lid 130 from sliding on the upper base surface 114. The first lid end wall 136 and the second lid end wall 137 can generally define a width W₁ of the container lid 130, and the first lid sidewall 134 and the second lid sidewall 135 can generally define a length L₁ of the container lid 130. In the present aspect, the width W₁ of the container lid 130 and the length L₁ of the container lid 130 can be substantially consistent between the upper lid end 140 and the lower lid end 148. In other aspects, the width W₁ and/or the length L₁ may not be consistent between the upper lid end 140 and the lower lid end 148. For example, in another aspect, the width W₁ and the length L₁ may taper from the lower lid end 148 to the upper lid end 140.

In the present aspect, each of the first and second lid sidewalls 134,135 and the first and second lid end walls 136,137 can be substantially planar; however, in other aspects, the first and second lid sidewalls 134,135 and/or the first and second lid end walls 136,137 can be curved or otherwise non-planar. The substantially vertical wall edges 150 defined between adjacent pairs of the first lid sidewall 134, the second lid sidewall 135, the first lid end wall 136, and the second lid end wall 137 can be substantially rounded or chamfered, as shown. In other aspects, any of the substantially vertical wall edges 150 can be less rounded and more angular.

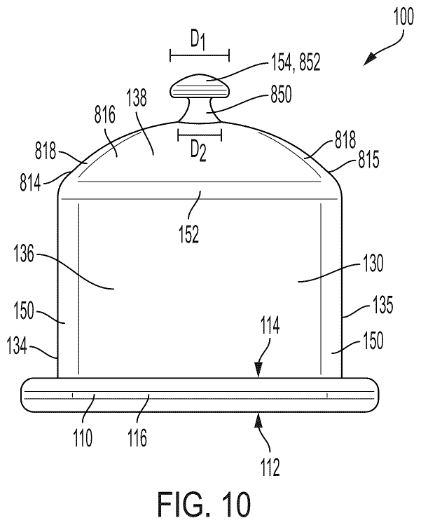

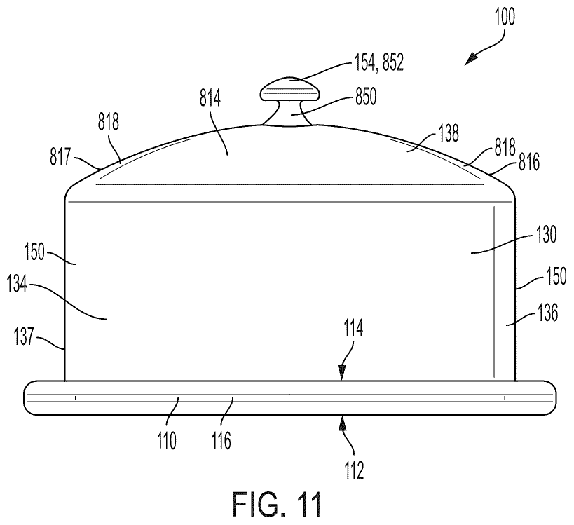

The lid housing 132 can define the upper lid wall 138 at the upper lid end 140 thereof. The upper lid wall 138 can be substantially domed or curved in the present aspect. That is, the upper lid wall 138 can be substantially convex, as shown. The upper lid wall 138 can define a first side face 814 extending upwardly from the first lid sidewall 134, a second side face 815 extending upwardly from the second lid sidewall 135, a first end face 816 extending upwardly from the first lid end wall 136, and a second end face 817 extending upwardly from the second lid end wall 137. Each of the first and second side faces 814,815 and the first and second end faces 816,817 of the upper lid wall 138 can be substantially convex, as best seen in FIGS. 10 and 11. In other aspects, however, the upper lid wall 138 can be substantially planar, as shown in the aspect of FIGS. 1-7.

In the present aspect, the first end face 816 can meet the second end face 817 at the center of the upper lid wall 138, as shown. Each of the first and second side faces 814,815 can extend towards, but may not reach, the center of the upper lid wall 138. In other aspects, the first and second end faces 816,817 and the first and second side faces 814,815 may all meet at the center of the upper lid wall 138. In other aspects, the first side face 814 and the second side face 815 can meet at the center of the upper lid wall 138, and the first and second end faces 816,817 can extend towards, but may not reach, the center of the upper lid wall 138.

The substantially horizontal transition edges 152 defined between the upper lid wall 138 and each of the first lid sidewall 134, the second lid sidewall 135, the first lid end wall 136, and the second lid end wall 137 can be substantially rounded or chamfered. Additionally, a lid edge 818 defined between each adjacent pair of the first and second side faces 814,815 and the first and second end faces 816,817 of the upper lid wall 138 can be substantially rounded or chamfered. In other aspects, any of the substantially horizontal transition edges 152 and/or the lid edges 818 can be less rounded and more angular.

The container lid 130 can also comprise the one or more knobs 154 and/or handles. The container lid 130 of the present aspect comprises a singular one of the knobs 154 mounted to and extending upward from the center of the upper lid wall 138. The knob 154 can be formed monolithically with the lid housing 132, as previously described. In other aspects, the one or more knobs 154 or handles can extend from the lid housing 132 at any other suitable location. Other aspects of the container lid 130 may not comprise any knobs 154 or handles. In example aspects, the knob 154 can comprise a knob stem 850 coupled to the upper lid wall 138 and a knob grip 852 coupled to the knob stem 850 distal to the upper lid wall 138. Referring to FIG. 10, the knob 154 can be substantially mushroom-shaped, wherein a grip diameter D₁ or width of the knob grip 852 can be larger than a stem diameter D₂ or width of the knob stem 850 at a distal stem end 1054 (shown in FIG. 10) thereof. A user can grasp the knob grip 852 to lift and replace the container lid 130 off of and on to the container base 110. In other aspects, the knob(s) 154 and/or handles can define any other suitable shape.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A food container comprising:
a container base defining an upper base surface, the upper base surface defining a food support region configured to support a food item thereon;
a container lid removably engaging the container base in a closed configuration, wherein the container base and the container lid together define a container cavity in the closed configuration for enclosing the food item, the container lid being substantially transparent for visibility of the food item enclosed within the container cavity.

2. The food container of claim 1, wherein the upper base surface further defines an outer rim portion surrounding the food support region and arranged external to the container cavity.

3. The food container of claim 2, wherein:
the upper base surface further defines a lid groove disposed between the outer rim portion and the food support region;
the lid groove encircles the food support region; and
a lower lid end of the container lid engages the lid groove in the closed configuration to prevent the container lid from sliding on the upper base surface.

4. The food container of claim 1, wherein:
the container lid comprises a lid housing defining a lower lid end and an upper lid end:
the lower lid end of the container lid engages the upper base surface in the closed configuration;
the lid housing comprises a first lid sidewall, a second lid sidewall opposite the first lid sidewall, a first lid end wall, and a second lid end wall opposite the first lid end wall, each extending from the lower lid end to the upper lid end; and
the lid housing further comprises an upper lid wall formed at the upper lid end.

5. The food container of claim 4, wherein:
each of first lid sidewall, the second lid sidewall, the first lid end wall, the second lid end wall, and the first lid end wall are substantially planar;
the first lid sidewall is substantially parallel to the second lid sidewall;
the first lid end wall is substantially parallel to the second lid end wall; and
each of the first lid sidewall and the second lid sidewall are substantially perpendicular to each of the first lid end wall and the second lid end wall.

6. The food container of claim 5, wherein:
a wall edge is defined between each adjacent pair of the first lid sidewall, the second lid sidewall, the first lid end wall, and the second lid end wall; and
each of the wall edges is substantially rounded.

7. The food container of claim 6, wherein:
a transition edge is defined between each of the upper lid wall and the first lid sidewall, the second lid sidewall, the first lid end wall, and the second lid end wall; and
each of the transition edges is substantially rounded.

8. The food container of claim 4, wherein the upper lid wall is substantially domed.

9. The food container of claim 8, wherein the upper lid wall defines a first side face extending from the first lid sidewall, a second side face extending from the second lid sidewall, a first end face extending from the first lid end wall, and a second end face extending from the second lid end wall.

10. The food container of claim 9, wherein:
the first end face meets the second end face at a center of the upper lid wall; and
each of the first side face and the second side face extend towards, but do not reach, the center of the upper lid wall.

11. The food container of claim 8, wherein:
a lid edge is defined between each adjacent pair of the first side face, the second side face, the first end face, and the second end face; and
each of the lid edges is substantially rounded.

12. The food container of claim 4, wherein the container lid further comprises a handgrip configured to be gripped by a user to remove the container lid from the container base in an open configuration and to replace the container lid back onto the container base in the closed configuration.

13. The food container of claim 12, wherein the handgrip is formed monolithically with the lid housing.

14. The food container of claim 13, wherein the handgrip is a knob formed monolithically with the lid housing at a center of the upper lid wall.

15. The food container of claim 14, wherein:
the knob comprises a knob stem and a knob grip;
the knob stem defines a stem width at a distal stem end;
the knob grip defines a grip width; and
the grip width is greater than the stem width.

16. A method of storing a food item in a food container, the method comprising:
providing the food container, the food container comprising a container base and a container lid, the container base defining an upper base surface, the upper base surface defining a food support region configured to support the food item thereon, the container lid being substantially transparent;
positioning the food item on the food support region in an open configuration of the food container;
placing the container lid onto the container base in a closed configuration of the food container, the container base and the container lid together define a container cavity in the closed configuration for enclosing the food item.

17. The method of claim 16, wherein the upper base surface further defines an outer rim portion surrounding the food support region and arranged external to the container cavity in the closed configuration.

18. The method of claim 17, wherein:
the upper base surface further defines a lid groove disposed between the outer rim portion and the food support region;
the lid groove encircles the food support region; and
placing the container lid onto the container base comprises engaging a lower lid end of the container lid with the lid groove to prevent the container lid from sliding on the upper base surface.

19. The method of claim 16, wherein:
the container lid comprises lid housing and a handgrip formed monolithically with the lid housing; and
placing the container lid onto the container base comprises gripping the handgrip, lowering the container lid onto the container base, and releasing the handgrip.

20. The method of claim 19, wherein:
the lid housing defines an upper lid end and a lower lid end;
the lid housing comprises an upper lid wall formed at the upper lid end; and
the handgrip is a knob formed monolithically with the lid housing at a center of the upper lid wall.
